(19) United States
(12) Patent Application Publication
(10) Pub. No.: US 2025/0055549 A1
(43) Pub. Date: Feb. 13, 2025

(54) SYSTEM AND METHOD FOR BEAM TRACKING USING GRAPH NEURAL NETWORKS

(71) Applicant: Samsung Electronics Co., Ltd., Gyeonggi-do (KR)

(72) Inventors: Shailesh CHAUDHARI, San Diego, CA (US); Hyuk Joon KWON, San Diego, CA (US); Karl CHAHINE, San Diego, CA (US)

(21) Appl. No.: 18/543,623

(22) Filed: Dec. 18, 2023

Related U.S. Application Data
(60) Provisional application No. 63/531,195, filed on Aug. 7, 2023.

(51) Int. Cl. H04B 7/06

(52) U.S. Cl. CPC H04B 7/06952

(57) ABSTRACT

A system and a method are disclosed for performing beam tracking using a GNN. A method of beam prediction by a UE includes receiving an input feature vector; comparing the input feature vector to a lookup table of rated predicted beams; selecting a corresponding predicted beam having a highest rating from the lookup table; and receiving, from a base station, a signal using the selected predicted beam.

### CROSS-REFERENCE TO RELATED APPLICATION

This application claims the priority benefit under 35 U.S.C. § 119 (e) of U.S. Provisional Application No. 63/531,195, filed on Aug. 7, 2023, the disclosure of which is incorporated by reference in its entirety as if fully set forth herein.

### TECHNICAL FIELD

The disclosure generally relates to beam tracking in a 5th generation (5G) new radio (NR) network. More particularly, the subject matter disclosed herein relates to improvements to beam tracking using a graph neural network (GNN).

### SUMMARY

In 5G NR specifications, beam sweeping is generally defined as a set of three procedures denoted as P1, P2, and P3.

In P1, both a user equipment (UE) and a base station (e.g., a next generation node B (gNB)) sweep over all possible beam pairs to select a best beam pair based on reference signal received power (RSRP).

In P2, the UE's beam is fixed and the gNB's beam is refined.

In P3, the gNB's beam is fixed and the UE's beam is refined.

For example, the P1, P2, and P3 may be summarized as shown in Table 1 below.

TABLE 1

| Process | Functionality | Description |
|---|---|---|
| P1 | Beam Selection | A gNB sweeps a transmission reception |
| | | point (TRP) beam, and a UE sweeps a UE |
| | | beam and selects a best one (e.g., the best |
| | | TRP beam measured by the best UE |
| | | beam) and reports it to the gNB. |
| P2 | Beam Refinement | A gNB refines a beam (e.g., sweeping |
| | for transmitter | narrower beam over narrower range) and |
| | (gNB Tx) | the UE detects the best one and reports it |
| | | to the gNB. |
| P3 | Beam Refinement | The gNB fixes a beam (e.g., transmits the |
| | for receiver | same beam repeatedly) and the UE refines |
| | (UE Rx) | its receiver beam. |

However, UE beam tracking (or refinement) via P3 can be of high complexity, leading to a reduction in throughput.

To solve this type of problem, some conventional methods conduct beam tracking by using additional prior information such as UE measurements, or by tracking an angle of arrival (AoA). However, such methods rely on the presence of additional inputs, such as sensor measurements and a true estimate of an initial AoA. In these cases, the presence of such additional inputs can result in even higher complexity to the system, leading to another reduction in throughput.

To overcome these issues, systems and methods are described herein, which utilize a learning-based approach for beam tracking using a GNN.

In accordance with an aspect of the disclosure, a future beam may be predicted by using various features, e.g., a previous beam, past RSRP measurements, etc.

In accordance with another aspect of the disclosure, a quantization strategy is provided to map real-valued RSRP measurements into discrete bins.

In accordance with another aspect of the disclosure, a rating-generation algorithm is provided to assign a rating between input features and future candidate beams, and then output a partially-completed rating matrix.

In accordance with another aspect of the disclosure, a method is provided for training a GNN that receives a partially-completed rating matrix as an input, and outputs a completed rating matrix.

In accordance with another aspect of the disclosure, during inference, a GNN trained rating matrix may be used to predict a best beam based on input features.

In accordance with another aspect of the disclosure, a GNN-trained rating matrix is provided in multiple input, multiple output (MIMO) receivers, enhancing RSRP.

The input of the GNN-trained rating matrix may be a previous beam as well as past RSRP measurements, and the output of the GNN-trained rating matrix is a predicted beam. For example, the GNN-trained rating matrix can predict the future beam using the previous beam and RSRP measurements as input features, without needing additional prior information such as sensor measurements or explicit AoA estimates.

The above approaches improve on previous methods by improving RSRP levels compared to baselines that rely on AoA estimation. Additionally, embodiments of the disclosure do not rely on the presence of prior information such as a UE's location or an AoA estimate, thereby being less complex than the above-described conventional methods.

In an embodiment, a method of beam prediction by a UE is provided. The method includes receiving an input feature vector; comparing the input feature vector to a lookup table of rated predicted beams; selecting a corresponding predicted beam having a highest rating from the lookup table; and receiving, from a base station, a signal using the selected predicted beam.

In an embodiment, a UE is provided, which includes a transceiver; and a processor configured to receive an input feature vector, compare the input feature vector to a lookup table of rated predicted beams, select a corresponding predicted beam having a highest rating from the lookup table, and receive, from a base station, a signal using the selected predicted beam.

In an embodiment, a non-transitory computer-readable storage medium is provided that stores a computer program, wherein the computer program, when executed by a processor, causes the processor to implement a method including receiving an input feature vector; comparing the input feature vector to a lookup table of rated predicted beams; selecting a corresponding predicted beam having a highest rating from the lookup table; and receiving, from a base station, a signal using the selected predicted beam.

### BRIEF DESCRIPTION OF THE DRAWING

In the following section, the aspects of the subject matter disclosed herein will be described with reference to exemplary embodiments illustrated in the figures, in which:

FIG. 1 illustrates an example of offline GNN training, according to an embodiment;

FIG. 2 illustrates an example of beam tracking at inference, according to an embodiment;

FIG. 3 illustrates a GNN architecture, according to an embodiment;

FIG. 4 is a flow chart illustrating a method of beam prediction by a UE, according to an embodiment;

FIG. 5 is a block diagram of an electronic device in a network environment, according to an embodiment; and

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

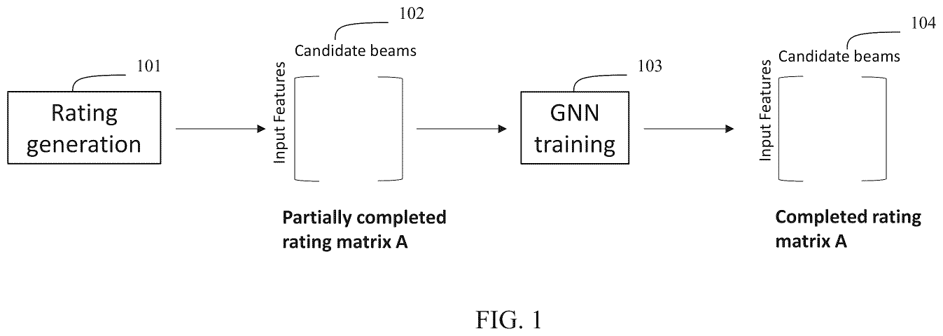

FIG. 1 illustrates an example of offline GNN training, according to an embodiment.

Referring to FIG. 1, a rating construction operation is performed at 101 to generate a partially completed rating matrix 102, where each entry in the rating matrix represents a rating of a particular feature that has been assigned to a particular beam. The partially completed rating matrix will have both known and unknown entries.

After GNN training is performed at 103, a completed rating matrix 104 is provided. That is, all of the ratings in the rating matrix 104 will be known.

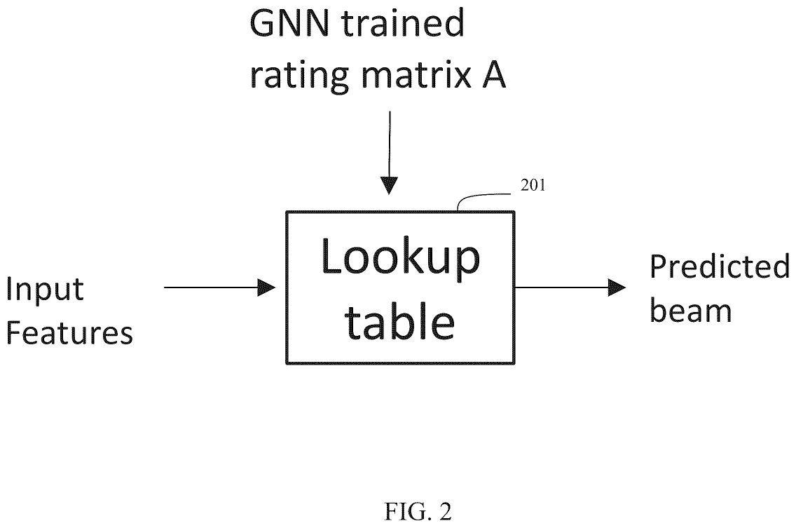

FIG. 2 illustrates an example of beam tracking at inference, according to an embodiment.

Referring to FIG. 2, a completed rating matrix, after GNN training, e.g., as illustrated in FIG. 1, may be used as a lookup table 201. More specifically, after receiving input features and comparing the received input features to the corresponding ratings in the lookup table 201, a beam with a highest rating is output as a predicted beam.

### System Model and Objective

Herein, MIMO orthogonal frequency division multiplexing (OFDM) transmission is described as an example, where K OFDM symbols are transmitted per time slot t, and N is fast Fourier transform (FFT) size.

Additionally, yₜ is a received signal at reception (Rx).

A combiner a*(b) may be selected from a codebook, where b is a steering direction, a(⋅) is an array response vector, and * denotes a conjugate transpose.

After applying the combiner, a combined signal may be represented as shown in Equation (1):

$${y}_{t}^{( c )} = a * ( b ) {y}_{t} \qquad ( 1 )$$

After Rx combining, a cyclic prefix may be removed and an FFT operation may be performed to extract data and pilot resource elements (REs), which results in a frequency domain vector Yₜ that includes both data and pilot REs, as shown in Equation (2) below:

$${Y}_{t} = {[ {Y}_{t} ( 1 ) , {Y}_{t} ( 2 ) , … , {Y}_{t} ( KN ) ]}^{T} \qquad ( 2 )$$

To measure the performance of the model, a normalized RSRP may be used as an indicator. That is, all pilot REs are extracted from Yₜ. Here, Yₜ^{p} denotes a vector of pilots extracted from Yₜ and assuming a total of P pilot REs per OFDM slot, a normalized RSRP may be calculated using Equation (3):

$${p}_{t} = \frac{1}{P {σ}^{2}} {\sum }_{i = 1}^{P} {\vert {Y}_{t}^{p} ( i ) \vert}^{2} \qquad ( 3 )$$

In Equation (3), σ² is a variance of gaussian noise added to the transmitted signal.

Here, it is assumed that the beam steering direction b is determined via beam sweeping every t_{sweep} time slots, and that beam tracking is triggered whenever a normalized RSRP drops below a threshold χ, i.e., when pₜ<χ.

### GNN Architecture

As described above, beam tracking is triggered whenever pₜ<χ. The past W RSRP measurements and the previously used beam may be used as the features.

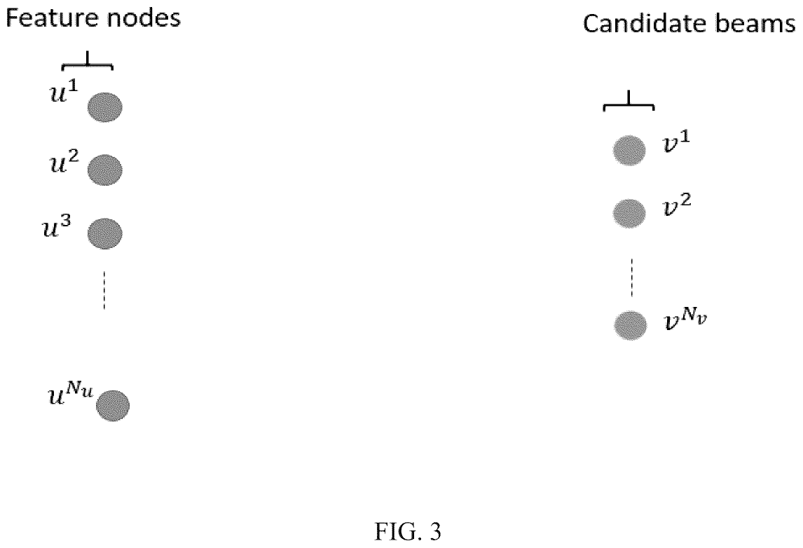

FIG. 3 illustrates a GNN architecture, according to an embodiment.

Referring to FIG. 3, u¹, u², . . . , u^{N}^{ᵤ} represent feature nodes and v¹, v², . . . , v^{N}^{ᵥ} represent candidate beam nodes. Here, Nᵥ indicates a number of candidate beams in a codebook.

Designing feature nodes requires careful design. As described above, a feature vector includes a previously used beam and past W RSRP measurements. The previously used beam can take one of Nᵥ possible values, however, the RSRP measurement is a real number and should be quantized. For example, each normalized RSRP measurement may be quantized into V regions based on its empirical cumulative distribution function (CDF). Therefore, Nᵤ=NᵥV^{W}.

### Rating Generation

To generate training data for the GNN, ratings (connections) are built between the feature nodes and candidate beam nodes. Herein, r^{i,j} denotes the rating between a feature node uⁱ and a candidate beam v^{j}. All ratings are initialized to 0, i.e., r^{i,j}=0 for i={1, 2, . . . , Nᵤ}, {j=1, 2, . . . , Nᵥ}.

To construct the ratings, a number of simulations, typically more than 10000, may be performed. During a simulation run, the feature vector {previously used beam, past normalized RSRP measurements} is observed and then quantized into one of the Nᵤ feature nodes, e.g., uⁱ. Assuming that v^{j} is the ideal beam for the next time slot, the rating r^{i,j} is incremented by 1.

After running a number of simulations, non-zero ratings may be obtained for many (but likely not all) edges.

Thereafter, the ratings are quantized into R discrete values.

To illustrate this process, let us consider a feature node uⁱ.

After running a number of simulations, uⁱ will have Nᵥ ratings for all candidate beams (r^{i,1}, r^{i,2}, . . . , r^{i,N}^{ᵥ}). To quantize the ratings, they are first normalized to \tilde{r}^{i,1}, \tilde{r}^{i,2}, . . . , \tilde{r}^{i,N}^{ᵥ}, where

$${\tilde{r}}^{i , j} = \frac{{r}^{i , j}}{{max}_{j} {r}^{i , j}} .$$

Once normalized, the ratings may be quantized into one of R discrete values using Equation (4).

$${\tilde{r}}_{i , j} = floor ( R {\tilde{r}}_{i , j} ) \qquad ( 4 )$$

A partial ratings matrix is then generated, where \tilde{r}_{i,j} is an element on an ith row and a jth column. The elements for which ratings are not observed are set to 0.

### GNN Training

After a partial ratings matrix is generated, some of the ratings may be masked (hidden), while the rest may be used for training the model. The hidden ratings may be used for testing.

A training procedure similar to that of recommender systems may be used. Through training, the GNN will equip each feature node uⁱ with a latent feature vector hᵤ_{ⁱ}, and each candidate beam node v^{j} with a latent feature vector hᵥ_{^{j}}.

The GNN output is a probability distribution p(\hat{r}^{i,j}=r) of the rating \hat{r}^{i,j} between nodes uⁱ and v^{j} over all possible ratings r∈{1, 2, . . . , R}. Here,

$$p ( {\hat{r}}^{i , j} = r ) = \frac{{e}^{{h}_{{u}^{i}}^{T} {Q}_{r} {h}_{{v}^{j}}}}{{\sum }_{s ∈ R} {e}^{{h}_{{u}^{i}}^{T} {Q}_{s} {h}_{{v}^{j}}}} ,$$

and Qᵣ is a rate-specific weight matrix.

During training, a negative log likelihood loss [symbol] , as shown in Equation (5), may be minimized.

$$ℒ = - {\sum }_{i , j ; {Ω}_{ij}} {\sum }_{r = 0}^{R} I [ {\tilde{r}}^{i , j} = r ] log p ( {\hat{r}}^{i , j} = r ) \qquad ( 5 )$$

In Equation (5), \tilde{r}^{i,j} is the true rating between node uⁱ and v^{j}, and Ω∈{0,1}^{N}^{ᵤ}^{×N}^{ᵥ} serves as a mask for unobserved ratings, such that ones occur for elements corresponding to observed ratings, and zeros for unobserved ratings. Hence, optimizing is only performed over observed ratings.

At the end of training, latent vectors hᵤ_{ⁱ}, hᵥ_{^{j}} and matrix Qᵣ are obtained.

The rating matrix is then completed as shown in Equation (6).

$${A}_{ij} = arg {max}_{r ∈ [ 1 , 2 , … R ]} p ( {\hat{r}}^{i , j} = r ) = arg {max}_{r ∈ [ 1 , 2 , … R ]} \frac{{e}^{{h}_{{u}^{i}}^{T} {Q}_{r} {h}_{{v}^{j}}}}{{\sum }_{s ∈ [ 1 , 2 , … R ]} {e}^{{h}_{{u}^{i}}^{T} {Q}_{s} {h}_{{v}^{j}}}}$$

### Beam Tracking at Inference

During inference, an input feature vector {previously used beam, past normalized RSRP measurements} may be quantized and mapped to one of the Nᵤ feature nodes, e.g., uⁱ. Thereafter, all of the candidate beams connected to uⁱ are compared and a beam node with the highest rating is selected using the GNN trained matrix.

Accordingly, a UE is able to determine an Rx beam for downlink reception without needing additional prior information such as sensor measurements or explicit AoA estimates.

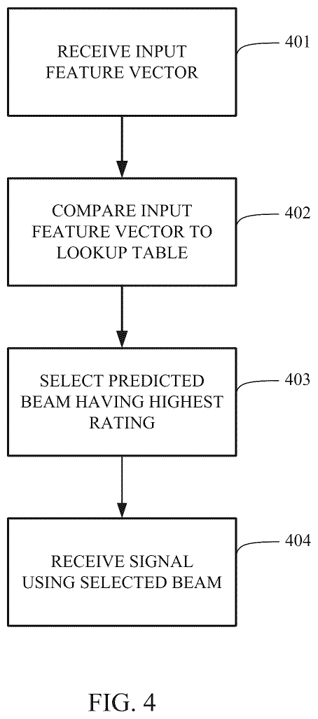

FIG. 4 is a flow chart illustrating a method of beam prediction by a UE, according to an embodiment.

Referring to FIG. 4, in step 401, the UE receives an input feature vector. As described above, the input feature vector may include a previously used beam and a plurality of past normalized RSRP measurements.

In step 402, the input feature vector is compared to a lookup table of rated predicted beams. As illustrated in FIG. 2, the lookup table includes a GNN trained rating matrix.

In step 403, a corresponding predicted beam having a highest rating is selected from the lookup table. As described above, all of the candidate beams connected to uⁱ are compared and a beam node with the highest rating is selected using the GNN trained matrix.

In step 404, the UE receives, from a base station, a signal using the selected predicted beam.

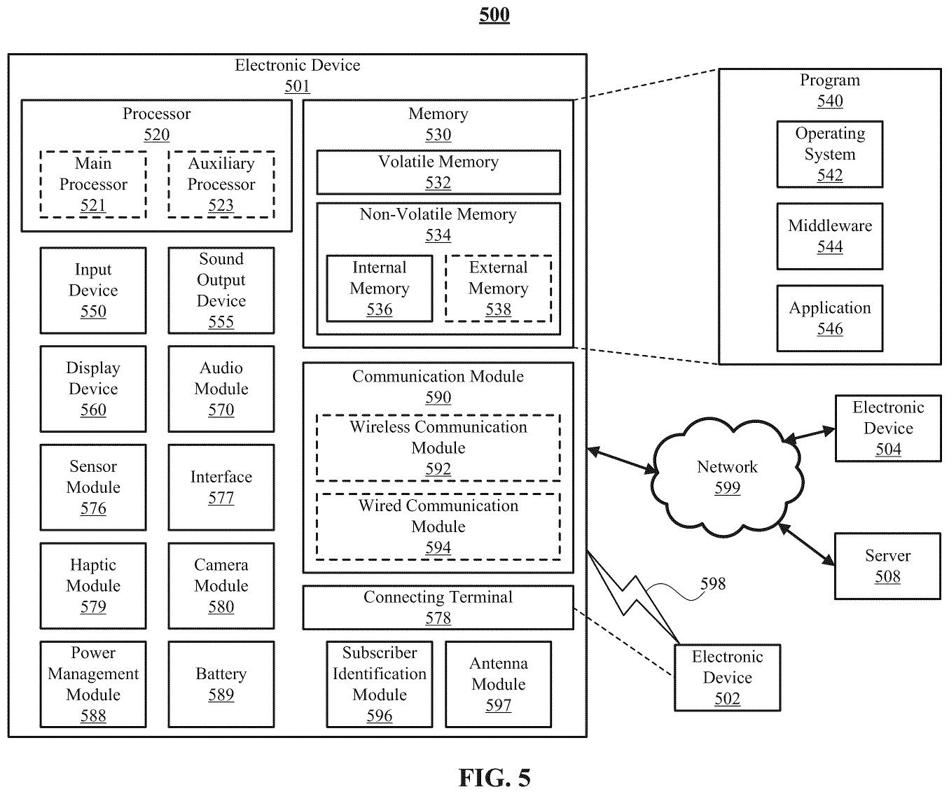

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations. For example, the processor 520 may execute software to performed the method illustrated in FIG. 4.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

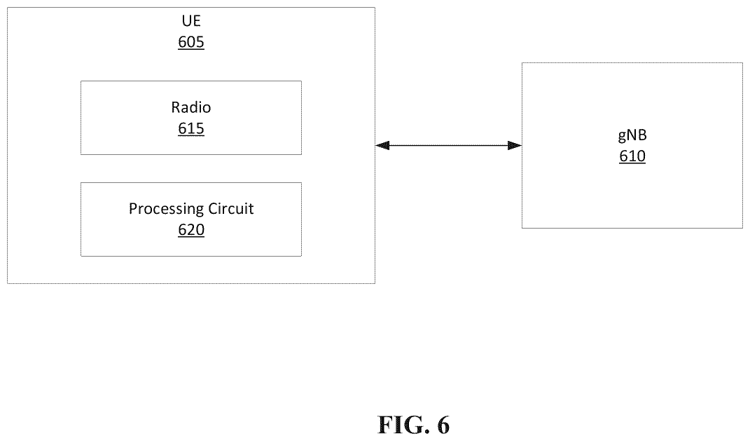

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 4. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of beam prediction by a user equipment (UE), the method comprising:
receiving an input feature vector;
comparing the input feature vector to a lookup table of rated predicted beams;
selecting a corresponding predicted beam having a highest rating from the lookup table; and
receiving, from a base station, a signal using the selected predicted beam.

2. The method of claim 1, wherein the input feature vector includes a previously used beam and a plurality of past normalized reference signal received power (RSRP) measurements.

3. The method of claim 1, wherein the lookup table includes a graph neural network (GNN) trained rating matrix, where each entry in the GNN trained rating matrix represents a rating of a feature that is assigned to a particular beam.

4. The method of claim 3, wherein the GNN trained rating matrix is generated by performing GNN training on a partially completed rating matrix.

5. The method of claim 4, wherein the partially completed rating matrix is generated using a rating-generation algorithm to assign ratings between a plurality of input features and future candidate beams.

6. The method of claim 1, wherein comparing the input feature vector to the lookup table of rated predicted beams comprises:
quantizing the input feature vector; and
mapping the quantized input feature vector to one of a plurality of feature nodes included in the lookup table.

7. The method of claim 1, further comprising triggering the beam prediction when a normalized reference signal received power (RSRP) measurement is below a predetermined threshold.

8. A user equipment (UE), comprising:
a transceiver; and
a processor configured to:
receive an input feature vector,
compare the input feature vector to a lookup table of rated predicted beams,
select a corresponding predicted beam having a highest rating from the lookup table, and
receive, from a base station, a signal using the selected predicted beam.

9. The UE of claim 8, wherein the input feature vector includes a previously used beam and a plurality of past normalized reference signal received power (RSRP) measurements.

10. The UE of claim 8, wherein the lookup table includes a graph neural network (GNN) trained rating matrix, where each entry in the GNN trained rating matrix represents a rating of a feature that is assigned to a particular beam.

11. The UE of claim 10, wherein the GNN trained rating matrix is generated by performing GNN training on a partially completed rating matrix.

12. The UE of claim 11, wherein the partially completed rating matrix is generated using a rating-generation algorithm to assign ratings between a plurality of input features and future candidate beams.

13. The UE of claim 8, wherein the processor is further configured to compare the input feature vector to the lookup table of rated predicted beams comprises by quantizing the input feature vector, and mapping the quantized input feature vector to one of a plurality of feature nodes included in the lookup table.

14. The UE of claim 8, wherein the processor is further configured to trigger beam prediction when a normalized reference signal received power (RSRP) measurement is below a predetermined threshold.

15. A non-transitory computer-readable storage medium that stores a computer program, wherein the computer program, when executed by a processor, causes the processor to implement a method comprising:
receiving an input feature vector;
comparing the input feature vector to a lookup table of rated predicted beams;
selecting a corresponding predicted beam having a highest rating from the lookup table; and
receiving, from a base station, a signal using the selected predicted beam.

16. The non-transitory computer-readable storage medium of claim 15, wherein the input feature vector includes a previously used beam and a plurality of past normalized reference signal received power (RSRP) measurements.

17. The non-transitory computer-readable storage medium of claim 15, wherein the lookup table includes a graph neural network (GNN) trained rating matrix, where each entry in the GNN trained rating matrix represents a rating of a feature that is assigned to a particular beam.

18. The non-transitory computer-readable storage medium of claim 17, wherein the GNN trained rating matrix is generated by performing GNN training on a partially completed rating matrix.

19. The non-transitory computer-readable storage medium of claim 18, wherein the partially completed rating matrix is generated using a rating-generation algorithm to assign ratings between a plurality of input features and future candidate beams.

20. The non-transitory computer-readable storage medium of claim 15, wherein comparing the input feature vector to the lookup table of rated predicted beams comprises:
quantizing the input feature vector, and
mapping the quantized input feature vector to one of a plurality of feature nodes included in the lookup table.
